(19) United States
(12) Patent Application Publication
(10) Pub. No.: US 2001/0053282 A1
(43) Pub. Date: Dec. 20, 2001

(54) Program recording/reproducing method and apparatus

(76) Inventors: Takeshi Mio, Tokyo (JP); Susumu Oka, Tokyo (JP); Kunio Shibata, Tokyo (JP)

Correspondence Address: BIRCH STEWART KOLASCH & BIRCH, PO BOX 747, FALLS CHURCH, VA, 22040-0747, US

(21) Appl. No.: 09/877,006

(22) Filed: Jun. 11, 2001

(30) Foreign Application Priority Data
Jun. 14, 2000 (JP) 2000-178797

(51) Int. Cl. H04N 5/92

(52) U.S. Cl. 386/108; 386/111

(57) ABSTRACT

A program recording/reproducing system demultiplexes predetermined program signals from multiplexed signals into which a plurality of program signals are time-division-multiplexed per predetermined multiplexing unit, and records these demultiplexed program signals. The predetermined program signals are extracted from the multiplexed signals, and the program signals are recorded. The program signals are read out of a recording medium, and the readout program signals are outputted so that an output interval on each multiplexing unit becomes coincident with a time interval in the multiplexed signals. A null packet is inserted in between the two readout program packets in the same state as when recorded, thereby troubleshooting a buffer overflow or underflow occurred during the reproducing process.

### CROSS REFERENCE TO RELATED APPLICATION

This application is based on Application No. 2000-178797 filed in Japan on Jun. 14, 2000, the contents of which are hereby incorporated by reference.

### BACKGROUND OF THE INVENTION

1. Field of the Invention

The present invention relates generally to a program recording/reproducing method and a program recording/reproducing apparatus for recording and reproducing multiplexed signals such as streaming signals based on an MPEG2-TS (Moving Picture Experts Group 2-Transport Stream), and more particularly to a program recording/reproducing method and a program recording/reproducing apparatus that are capable of troubleshooting a trouble such as a buffer overflow or underflow which occurs during a reproducing process while performing a record with a high efficiency.

2. Related Background Art

An apparatus for demultiplexing predetermined coded program signals out of multiplexed signals of which a plurality of program signals are time-division-multiplexed every predetermined multiplexing unit and recording/reproducing these demultiplexed program signals may be exemplified by a program recording/reproducing apparatus for extracting the predetermined coded program signals from streaming signals based on, e.g., the MPEG2-TS and recording/reproducing the extracted program signals. Note that the MPEG2-TS is defined as coding system standardized by the MPEG (Moving Picture Experts Group) and designed to multiplex and transmit mainly broadcasting programs.

FIG. 10 is a block diagram showing an architecture of a conventional program recording/reproducing apparatus for recording/reproducing the streaming signals based on the MPEG2-TS, disclosed in Japanese Patent Application Laid-Open No. Hei 10-23370. Referring to FIG. 10, the apparatus includes a record PSI (Program Specific Information) processing unit 26, a packet discriminator 27, a rate converting unit 28, a VCR signal formatter 29, a recording head 30, a magnetic tape 31, a reproducing head 32, an equalizer 33, a VCR signal de-formatter 34, a rate converting unit 35, a null packet generation unit 36, a changeover switch 37, a time reference information detection unit 38, an added packet count calculation processing unit 39, and a timing signal generation unit 40.

Next, functions thereof will be explained.

When the streaming signals based on the MPEG2-TS are inputted, the record PSI processing unit 26 outputs a control signal to the packet discriminator 27 on the basis of a record program number. The packet discriminator 27 extracts and outputs program packets of predetermined coded program signals on the basis of the control signal. The rate converting unit 28 coverts a bit rate of the packet, and the VCR signal formatter 29 converts it into a predetermined recording format. The program packets are then recorded on the magnetic tape 31 by the recording head 30.

Further, the signals read by the reproducing head 32 from the magnetic tape 31 are inputted to the VCR signal de-formatter 34 via the equalizer 33, wherein the signals are reproduced into the program packets. The reproduced program packets of the predetermined coded program signals are inputted to the rate converting unit 35. The time reference information detection unit 38 detects a speed of the streaming signal on the basis the time management information contained in the reproduced program packets. The added packet count calculation processing unit 39 calculates and outputs the number of lacking packets corresponding to the detected speed. Then, a train of program packets of which the lacking packets are supplemented with null packets, are outputted from the changeover switch under the control of the timing signal generation unit 40. The outputted program packets become the reproduced streaming signals.

Then, if this architecture is taken, highly efficient recording is attained by recording only the predetermined coded program signals on the magnetic tape 31. Further, during a reproducing process, the null packet is inserted between two pieces of program packets embedded with the time management information in order to keep a time interval therebetween, and the program packets can be reproduced in a state where the time management information is kept normally.

The conventional program recording/reproducing apparatus takes the architecture described above and is therefore certainly capable of reproducing the program packets while normally keeping the time management information. The conventional program recording/reproducing apparatus is not necessarily, however, capable of normally reproducing the program packets even when normally keeping the time management information, and a trouble such as a buffer overflow or underflow might occur during the reproducing process as the case may be.

This problem will be specifically explained.

FIG. 11 is an explanatory diagram showing a data flow of a process of recording/reproducing the coded program signals in the conventional program recording/reproducing apparatus. Referring to FIG. 11, there are shown an inputted steaming signal (a), a recorded streaming signal (b) recorded on the magnetic tape 31, and a reproduced streaming signal (c) outputted from the changeover switch 37, wherein each block implies one program packet. Then, only the predetermine coded program packets are simply extracted and recorded, and the reproduced streaming signals are generated by inserting the null packets by the number of lacking packets when in the reproducing process. In this case, as shown in FIG. 11, there might be disrupted a time relationship between the program packet embedded with the time management information and the program packet containing a time stamp indicating a start-of-decoding time and a display time. The problem is that this time mismatching causes a trouble such as a buffer overflow or underflow when decoding.

### SUMMARY OF THE INVENTION

It is a primary object of the present invention, which was devised to obviate the above problems inherent in the prior art, to provide a program recording/reproducing method and a program recording/reproducing apparatus that are capable of recording with a high efficiency and troubleshooting a trouble such as a buffer overflow or underflow which occurs during a reproducing process.

To accomplish the above object, according to a first aspect of the present invention, there is provided a program recording/reproducing method of demultiplexing predetermined program signals from multiplexed signals into which a plurality of program signals are time-division-multiplexed per predetermined multiplexing unit and recording these demultiplexed program signals, comprising an extracting step of extracting the predetermined program signals from the multiplexed signals, a recording step of recording the program signals on recording means, a reading step of reading the program signals out of the recording means, and a speed converting step of outputting the program signals read out so that an output interval on each multiplexing unit becomes coincident with a time interval in the multiplexed signals.

According to a second aspect of the present invention, a program recording/reproducing apparatus for demultiplexing predetermined program signals from multiplexed signals into which a plurality of program signals are time-division-multiplexed per predetermined multiplexing unit and recording these demultiplexed program signals, comprises extracting means for extracting the predetermined program signals from the multiplexed signals, recording means for recording the program signals, reading means for reading the program signals out of the recording means, and speed converting means for outputting the program signals read by the reading means so that the output interval on each multiplexing unit becomes coincident with the time interval in the multiplexed signals.

According to a third aspect of the present invention, there is provided a program recording/reproducing apparatus, to which streaming signals of which a plurality of program signals are time-division-multiplexed based on an MPEG2-TS are inputted, for demultiplexing predetermined coded program signals out of the streaming signals and recording these program signals, the apparatus comprising extracting means for extracting program packets of the predetermined coded program signals from the streaming signals, recording means for recording the respective program packets and a discarded packet count of the packets discarded between two consecutive program packets, reading means for reading the coded program signals out of the recording means, and speed converting means for outputting the coded program signals read out by the reading means after inserting null packets corresponding to the discarded packet count between the two consecutive program packets.

According to a fourth aspect of the present invention, the program recording/reproducing apparatus may further comprise speed detecting means for detecting a speed of the steaming signals based on the number of packets contained per unit time when receiving the streaming signals, wherein the speed detecting means may output the program signals at the detected speed.

According to a fifth aspect of the present invention, the program recording/reproducing apparatus according to the third aspect, may further comprise speed detecting means for detecting, during a reproducing process, a speed of the streaming signals on the basis of time management information contained in the streaming signals, wherein the speed converting means may output the coded program signals at the detected speed.

According to a sixth aspect of the present invention, in the program recording/reproducing apparatus according to the third aspect, the recording means may record one control packet structured in the same format as the program packet as a substitute for the discarded packet, thereby recording a discarded packet count of the packets discarded between two consecutive program packets.

According to a seventh aspect of the present invention, in the program recording/reproducing apparatus according to the third aspect, the recording means may record a discarded packet count of the packets discarded between two consecutive program packets at every interval therebetween, thereby recording a discarded packet count of the packets discarded between two consecutive program packets.

According to an eighth aspect of the present invention, in the program recording/reproducing apparatus according to the third aspect, wherein the recording means may record a stream management packet as a first recording packet of the predetermined coded program signal.

According to a ninth aspect of the present invention, in the program recording/reproducing apparatus according to the third aspect, the recording means may record a program packet containing time management information or an intra frame coded program packet after the stream management packet.

According to a tenth aspect of the present invention, in the program recording/reproducing apparatus according to the third aspect, the recording means may record each program packet and the discarded packet count of the packets discarded between the two consecutive program packets on a magnetic tape, a magnetic disk, or an optical disk.

### BRIEF DESCRIPTION OF THE DRAWINGS

Other features and advantages of the present invention will become readily apparent from the following description taken in conjunction with the accompanying drawings, in which:

FIG. 1 is a block diagram showing an architecture of a program recording/reproducing apparatus in an embodiment 1 of the present invention;

FIG. 2 is an explanatory diagram showing a data flow of a process of recording and reproducing predetermined coded program signals in the embodiment 1 of the present invention;

FIG. 3 is a block diagram showing an architecture of the program recording/reproducing apparatus in an embodiment 2 of the present invention;

FIG. 4 is an explanatory diagram showing a data flow of the process of recording and reproducing predetermined coded program signals in the embodiment 2 of the present invention;

FIG. 5 is a block diagram showing an architecture of the program recording/reproducing apparatus in an embodiment 3 of the present invention;

FIG. 6 is an explanatory diagram showing a data flow of the process of recording and reproducing predetermined coded program signals in the embodiment 3 of the present invention;

FIG. 7 is a block diagram showing an architecture of the program recording/reproducing apparatus in an embodiment 4 of the present invention;

FIG. 8 is an explanatory diagram showing a data flow of the process of recording and reproducing predetermined coded program signals in the embodiment 4 of the present invention;

FIG. 9 is a block diagram showing an architecture of the program recording/reproducing apparatus in an embodiment 5 of the present invention;

FIG. 10 is a block diagram showing an architecture of a conventional program recording/reproducing apparatus for recording and reproducing streaming signals based on an MPEG2-TS; and

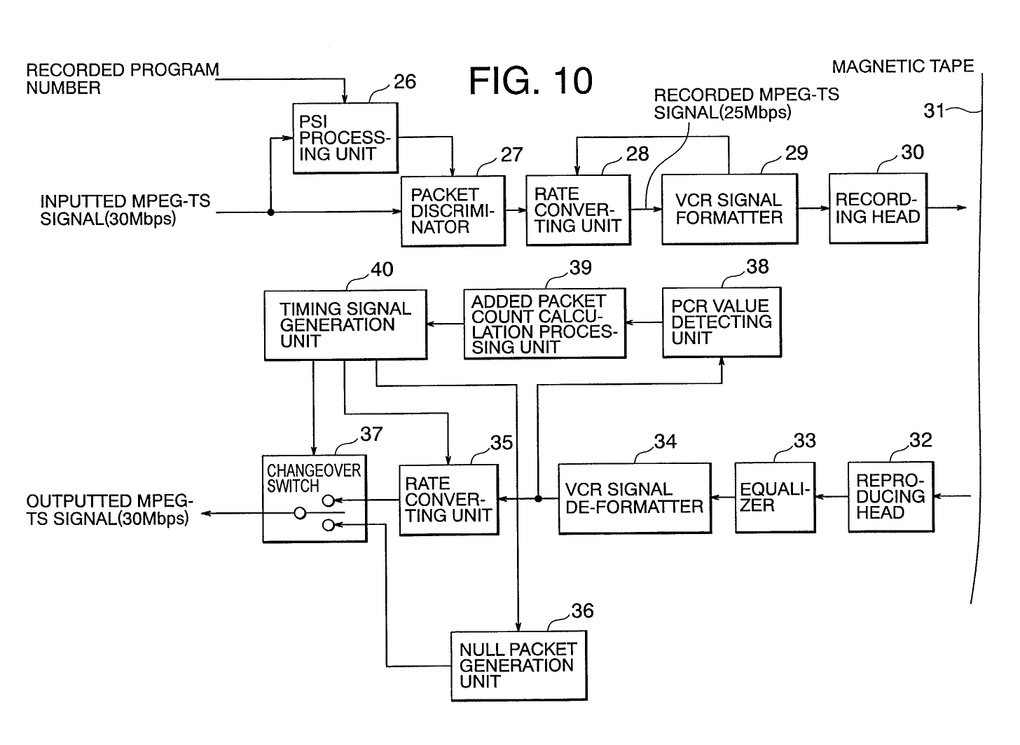

FIG. 11 is an explanatory diagram showing a data flow of a process of recording and reproducing coded program signals in a conventional program recording/reproducing apparatus.

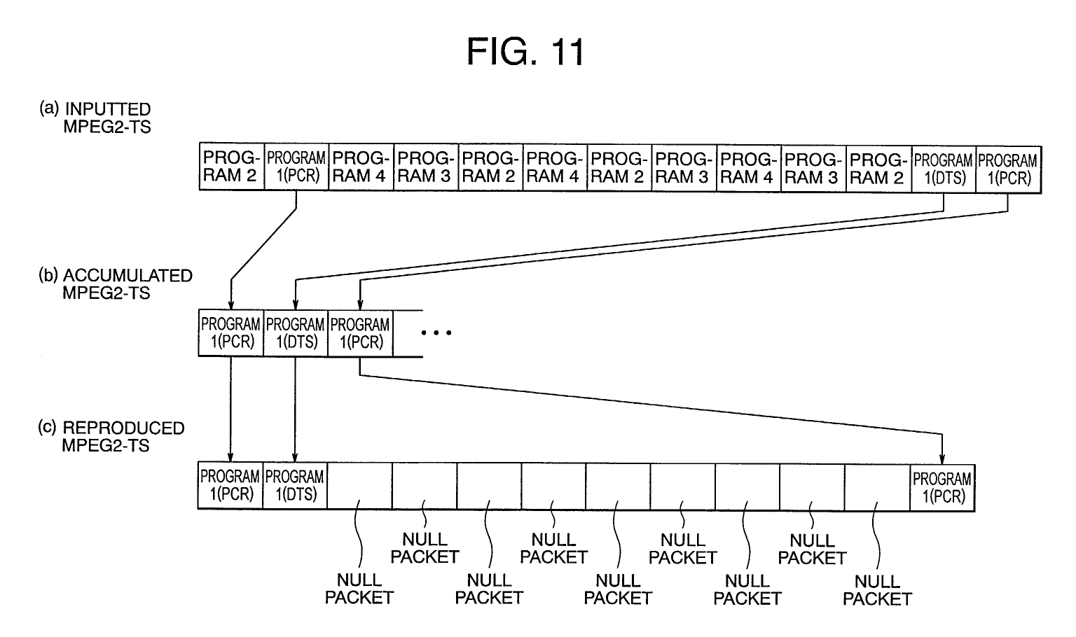

### DESCRIPTION OF THE PREFERRED EMBODIMENTS

Embodiments of the present invention will hereinafter be described with reference to the accompanying drawings.

Embodiment 1

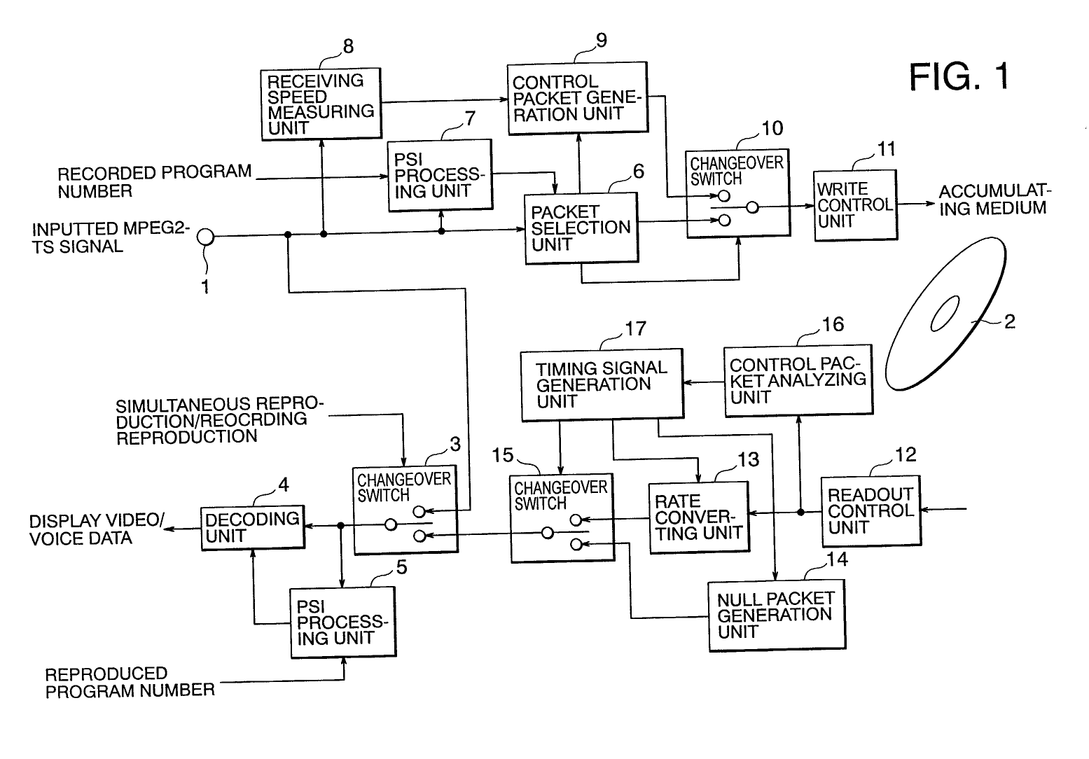

FIG. 1 is a block diagram showing an architecture of a program recording/reproducing apparatus in an embodiment 1 of the present invention. This program recording/reproducing apparatus is structured such that a plurality of program signals are coded based on the MPEG2-TS, streaming signals which have been subjected to time division multiplexing (TDM) are inputted, the predetermined coded program signals are demultiplexed from these streaming signals and then recorded, and the thus recorded coded program signals are reproduced and decoded. Note that the coded program signals in the streaming signals are composed of program packets containing media information such as video signals and voice signals, and of PSI packets containing program specification information of the program concerned. Further, a piece of time reference information known as a PCR (Program Clock Reference) and time stamps such as a PTS (Presentation Time Stamp) and a DTS (Decoding time Stamp), are properly recorded in each program packet, a reproduction timing between the program packets is controlled based on these pieces of time management information in the program recording/reproducing apparatus.

Referring again to FIG. 1, the program recording/reproducing apparatus includes an input terminal to which the streaming signals are inputted, a recording medium (recording means) 2 such as a magnetic tape, a magnetic disk or an optical disk on which the streaming signals are recorded, and a reproduction selecting switch 3, to which to input the input streaming signals inputted from the input terminal 1 and the reproduced streaming signals reproduced from the recording medium 2, for selecting either of these two flows of signals on the basis of a recording/reproducing control signal and outputting the thus selected streaming signals. The program recording/reproducing apparatus further includes a decoding unit 4 for generating predetermined program signals containing the video signals and the voice signals by decoding the selected streaming signals, and a reproduction PSI processing unit 5, to which a number for specifying the program to be reproduced and the selected streaming signals are inputted, for outputting to the decoding unit 4 a control signal for getting the predetermined coded program signals extracted based thereon.

Moreover, the program recording/reproducing apparatus includes a packet selection unit (extracting means) 6 for extracting the program packets of the predetermined coded program signals out of the inputted streaming signals and outputting a switch signal switched over when in the extraction process and when in a non-extraction process, a record PSI processing unit 7, to which to input a number for specifying the program to be recorded and the inputted streaming signals, for outputting to the packet selection unit 6 a control signal for getting the predetermined coded program signals extracted based thereon, a receiving speed measuring unit (speed detection means) 8 for measuring a transmission speed of the inputted streaming signal, and a control packet generation unit 9 for counting the number of packets discarded by the packet selection unit 6 on the basis of the switch signal of the packet selection unit 6 as well as on the speed measured and for outputting control packets containing pieces of discarded packet count information and receiving speed information. Still further, the program recording/reproducing apparatus includes a record selection switch 10 for selecting and outputting, if the program packets exist, the control packet during a period for which the programs do not exist on the basis of the switch signal, and a write control unit (recording means) 11 for recording the output of the record selection switch 10 on the recording medium 2. Note that the control packet is structured in the same format as the program packet is.

The program recording/reproducing apparatus has a readout control unit (reading means) 12 for reading the program packets and the control packets in their recording sequences out of the recording medium 2, a rate conversion unit (speed converting means 13, to which the program packets are inputted, for buffering these packets as the necessity may arise, a null packet generation unit (speed converting means) 14 for generating a null packet having the same structure as the program packet, a reproduction switch (speed converting means) 15, to which the program packets and the null packets are inputted, for outputting the reproduced streaming signals to the reproduction selection switch by sequentially outputting the program packets and the null packets, a control packet analyzing unit (speed converting means) 16, to which the control packet is inputted, for analyzing the control packet and outputting the discarded packet count information and the receiving speed information, and a timing signal generation unit (speed converting means) 17 for indicating an output speed of the packet to the rate converting unit 13 and the null packet generation unit 14 on the basis of the receiving speed information, and outputting control signals to the rate converting unit 13, the null packet generation unit 14 and the reproduction switch 15 on the basis of the discarded packet count information. This architecture makes it feasible to output the program packets of the predetermined coded program signals in the same sequence and at the same interval as those of the inputted streaming signals.

The discussion will next focus on functions thereof.

What is explained at first is a case where the inputted streaming signals are reproduced as they are. The recording/reproducing control signal is inputted to the reproduction selection switch 3, and a program number of the program to be reproduced is specified in the reproduction PSI processing unit 5. The reproduction selection switch 3 thereby selects and outputs the inputted streaming signals as the selected streaming signals. Then, the reproduction PSI processing unit 5 outputs program signals with the program number specified.

When the inputted streaming signals are inputted to the input terminal 1 in such a state, the inputted streaming signals are inputted to the decoding unit 4 via the reproduction selection switch 3. The decoding unit 4 extracts the program packets of the predetermined coded program signals based on the control signal mentioned above, and outputs the video signals and the voice signals by sequentially decoding the program packets extracted.

Given next is an explanation of a case where the inputted streaming signals are recorded on the recording medium 2 and reproduced and decoded. When specifying the program number of the program recorded on the record PSI processing unit 7, the record PSI processing unit 7 outputs to the packet selection unit 6 a control signal for extracting the coded program signals corresponding to the program number. The packet selection unit 6, when detecting the PSI packets and the program packets of the coded program signals in the inputted streaming signals, outputs these detected packets. Further, the packet selection unit 6 outputs the switch signal switched over when in the extraction process and when in the non-extraction process of the packets relative to the predetermined coded program signals.

The receiving speed measuring unit 8 measures the transmission speed of the inputted streaming signals. The control packet generation unit 9 counts the number of packets discarded by the packet selection unit 6 based on the speed measured and the switch signal given above, and outputs the control packet containing the discarded packet count information and the receiving speed information. Further, the record selection switch 10, if there are the program packets, selects and outputs the control packet during a period for which there is no program packet, (extracting step). The write control unit 11 records an output of the record selection switch 10 on the recording medium 2 (recording step).

The program packets are thereby recorded in a receiving sequence thereof on the recording medium 2, and, when the packet is discarded, a single piece of control packet containing the discarded packet count information within a packet discarding interval thereof is inserted in that discarded position and thus recorded.

The readout control unit 12 reads the program packets and the control packets from the recording medium 2 in the recording sequence thereof (reading step). Then, the program packets are inputted to the rate converting unit 13 and subjected to buffering according to the necessity. On the other hand, the control packets are inputted to the control packet analyzing unit 16. The control packet analyzing unit 16 analyzes the control packet, and outputs the discarded packet count information and the receiving speed information. The timing signal generation unit 17 indicates a packet output speed to the rate converting unit 13 and the null packet generation unit 14 to output the packet at the same speed as the receiving speed information indicates, and also outputs the control signals to the rate converting unit 13, the null packet generation unit 14, the reproduction switch 15 on the basis of the discarded packet count information. To be specific, the timing signal generation unit 17 generates a predetermined system clock and a synchronous count value on the basis of the receiving speed information and the time reference information, and operates the rate converting unit 13 to output the program packet at such a timing that the time management information is coincident with the synchronous count value. At the same time, the timing signal generation unit 17 indicates the reproduction switch 15 to select the output of the rate converting unit 13, and, at timings other than the above timing, operates the null packet generation unit 14. Then, the timing signal generation unit 17 indicates the reproduction switch 15 to select the output of the null packet generation unit 14 to output the null packet. Then, a train of packets outputted from the reproduction switch 15 are inputted as the reproduced streaming signals to the reproduction selection switch 3 (speed converting step). The functions other than what has been described so far are the same as those in the case of the inputted streaming signal, and therefore their repetitive explanations are omitted.

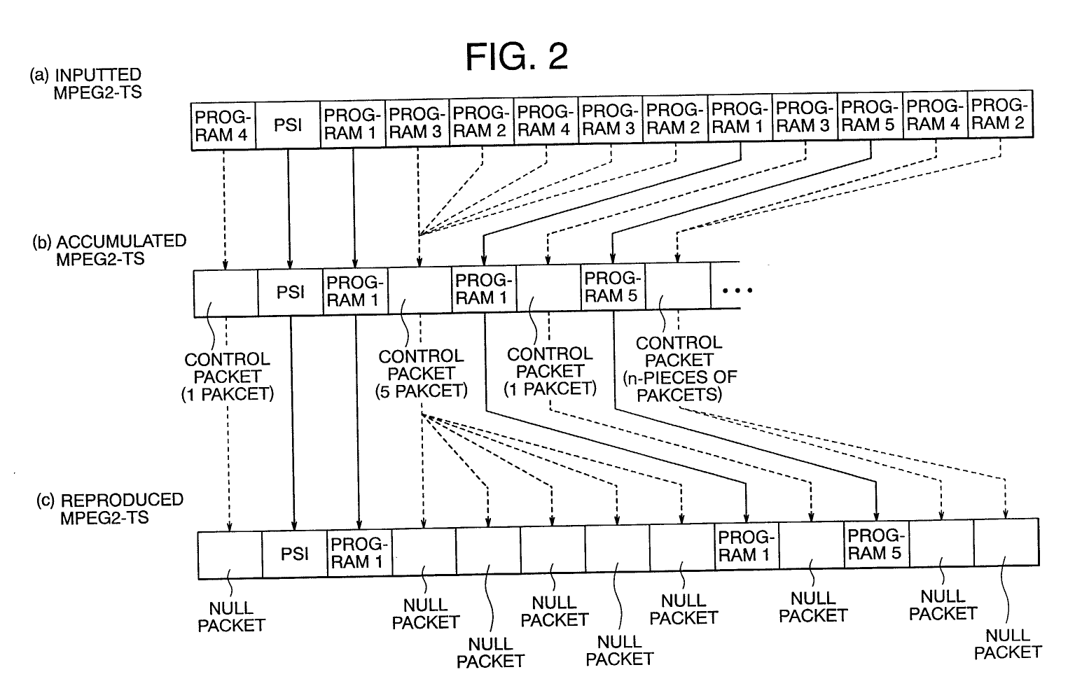

FIG. 2 is an explanatory diagram showing a data flow in the recording/reproducing process of the predetermined coded program signal in the embodiment 1 of the present invention. Referring to FIG. 2, a reference symbol (a) represents the inputted streaming signal inputted to the input terminal 1, (b) indicates the recorded streaming signal recorded on the recording medium 2, and (c) designates the reproduced streaming signal outputted from the reproduction switch 15. Each block implies one single program packet. Then, as shown in FIG. 2, after a start of recording, the packet selection unit 6 extracts and outputs the program packets with the specified program numbers ([Program 1] and [Program 5] in FIG. 2) and the PSI packet, and discards the packets excluding these packets. Instead, the control packets each containing the discarded packet count information are outputted one by one and recorded on the recording medium 2. Further, when reproduced, the null packets of which the number is the same as that of the discarded packet counts, are outputted based on the control packets and inserted in between the PSI packet and the program packet, thus reproducing the information signals.

Note that the process of reproducing the inputted streaming signals and the process of recording on the recording medium 2 are independent in terms of their processing units and can be therefore executed at the same time. Furthermore, a plurality of program numbers are specified in the recording process, whereby a plurality of programs can be simultaneously recorded on one single recording medium 2.

As discussed above, according to the embodiment 1, the program recording/reproducing apparatus, to which the streaming signals of which the plurality of coded program signals are time-division-multiplexed based on the MPEG2-TS are inputted, demultiplexes the predetermined coded program signals out of the streaming signals and records these program signals. The program recording/reproducing apparatus includes the packet selection unit 6 for extracting the program packets of the predetermined coded program signals from the streaming signals, the recording medium 2 for recording the respective program packets and the discarded packet count of the packets discarded between the two consecutive program packets, the readout control unit 12 for reading the coded program signals out of the recording medium 2, and the reproduction switch 15 for outputting the coded program signals read out by the readout control unit 12 in a way that inserts the null packets corresponding to the discarded packet count in between the two consecutive program packets. With this architecture, it is possible to attain the efficient recording by discarding the packets other than the predetermined coded program signals. Besides, the algorithm taken when reproduced is not that the respective program packets are simply read from the recording medium 2 and thus outputted, but that the readout program packets are outputted after the output interval of each packet has been set coincident with the time interval of the streaming signal. Therefore, a state of the reproduced program packet becomes the same as a state on the streaming signal, thereby obtaining an effect in which a trouble such as a buffer overflow or underflow does not occur in the decoding unit 4 or the like.

Especially, the control packet containing the discarded packet count information is recorded, and hence the recording can be executed by far more efficiently than in the case of simply recording the inputted streaming signals as they are.

The embodiment 1 involves providing the receiving speed measuring unit 8 for detecting a speed of the steaming signals based on, for instance, the number of packets contained per unit time when receiving the streaming signals. The reproduction switch 15 outputs the coded program signals at the speed detected. Hence, there are obtained effects in which the reproduced program packets can be brought into absolutely the same state as in the case of extracting the program packets directly from on the streaming signals and reproducing them, and the trouble such as the buffer overflow or underflow in the decoding unit 4 can be more surely prevented. Further, the streaming signals and the reproduced coded program signals can be brought into the same sate, and hence an effect obtained is that the single decoding unit is capable of similarly decoding the predetermined coded program signals.

Embodiment 2

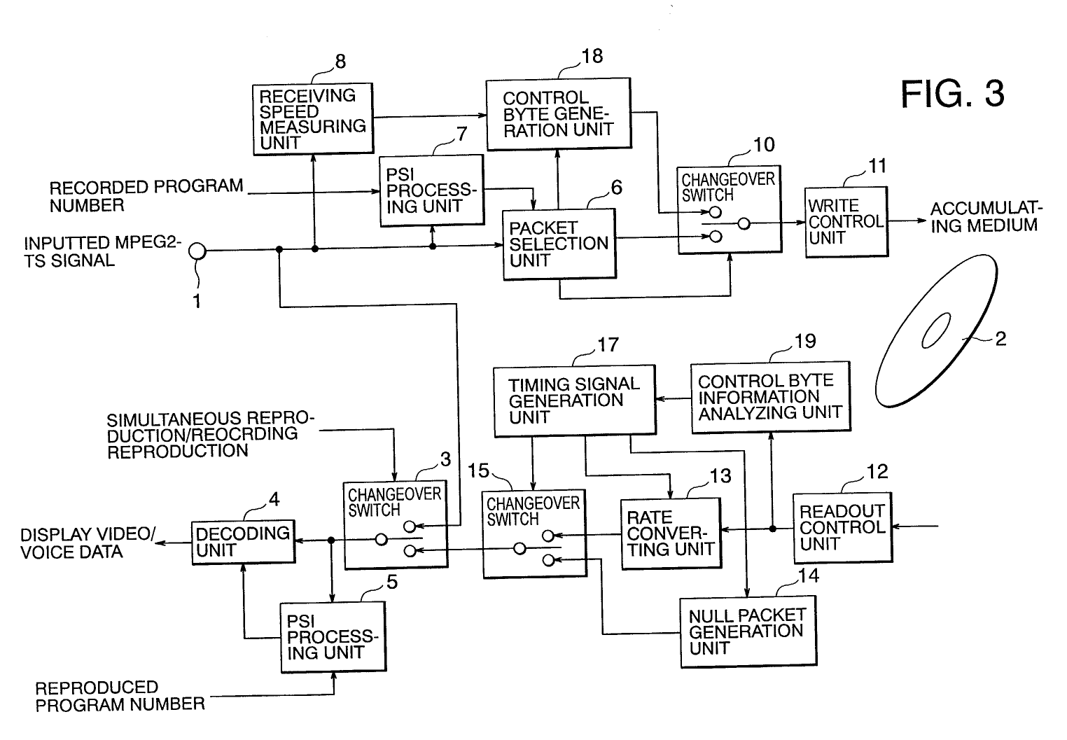

FIG. 3 is a block diagram showing an architecture of the program recording/reproducing apparatus in an embodiment 2 of the present invention. Referring to FIG. 3, elements characteristic of the embodiment 2 are a control byte information generation unit 18 for counting the number of packets discarded by the packet selection unit 6 on the basis of the measured speed and the switch signal of the packet selection unit 6 and outputting control byte information containing the discarded packet count information and the receiving speed information, and a control byte information analyzing unit (speed converting means) 19, to which the control byte information is inputted, for analyzing the control byte information and outputting the discarded packet count information and the receiving speed information. Then, the control byte information is structured by a much smaller number of bytes than the number of bytes of the program packet. Configurations other than the above-mentioned are the same as those in the embodiment 1, and the repetitive explanations are omitted.

Next, the functions thereof will be described.

The control byte information generation unit 18 counts the number of packets discarded by the packet selection unit 6 on the basis of the measured speed and the switch signal of the packet selection unit 6, and outputs the control byte information containing the discarded packet count information and the receiving speed information. The record selection switch 10 outputs the control byte information with a switchover to the program packet. The write control unit 11 records the control byte information on the recording medium 2. Further, the readout control unit 12 reads the control byte information with the switchover to the program packet. The control byte information analyzing unit 19 analyzes the control byte information and outputs the discarded packet count information and the receiving speed information. Functions other than what has been described so far are the same as those in the embodiment 1, and hence the repetitive explanations are omitted.

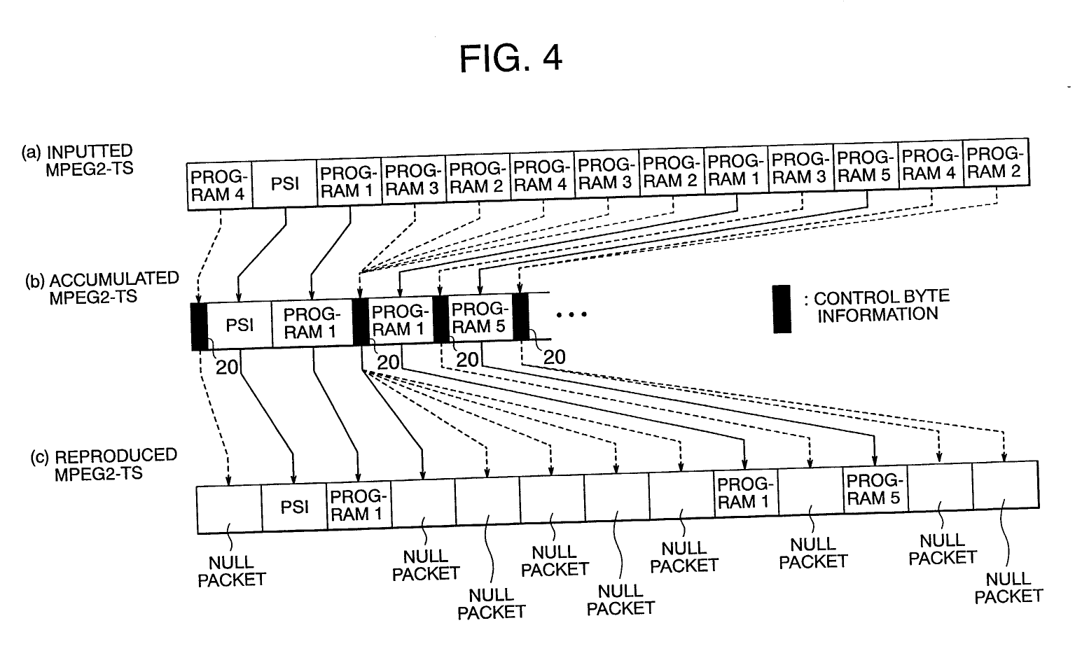

FIG. 4 is an explanatory diagram showing a data flow in a process of recording and reproducing the predetermined coded program signals in the embodiment 2 of the present invention. Referring to FIG. 4, the numeral 20 represents the control byte information.

As explained above, in the embodiment 2, the control byte information generation unit 18 generates the control byte information containing the discarded packet count information between the two consecutive program packets, and the write control unit 11 writes the control byte information on the recording medium 2. It is therefore feasible to reduce a quantity of the information recorded for recording the discarded packet count down to a much smaller level than in the embodiment 1. Hence, there is obtained an effect that the recording efficiency can be drawn out at the maximum.

Embodiment 3

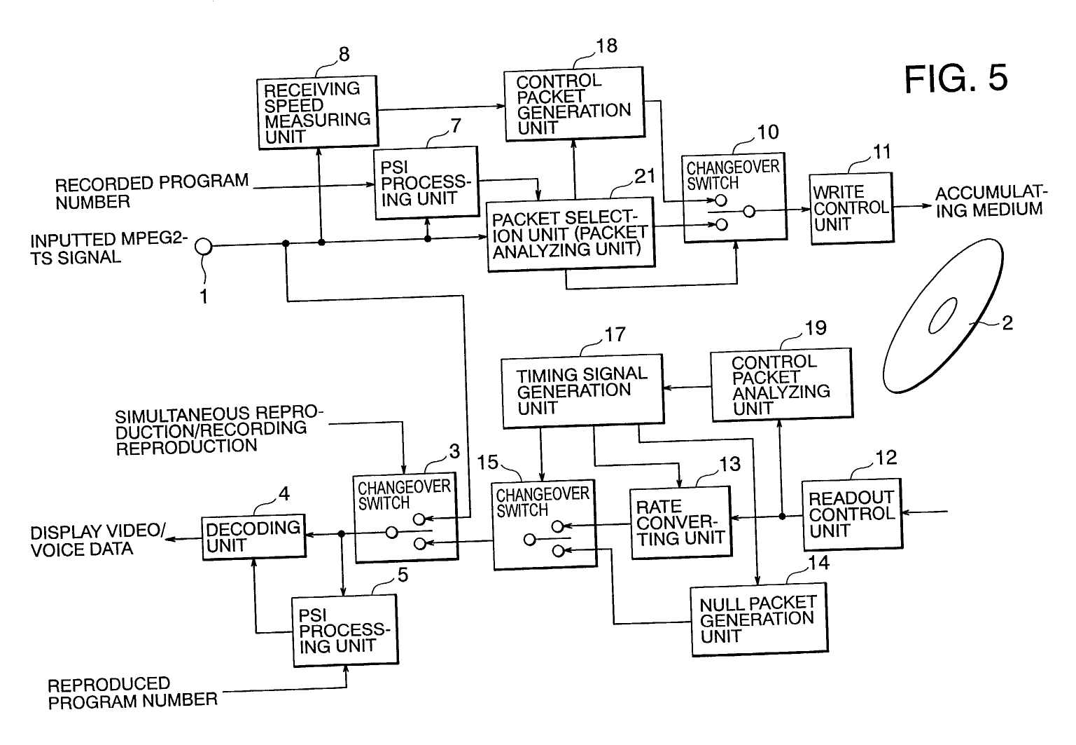

FIG. 5 is a block diagram showing an architecture of the program recording/reproducing apparatus in an embodiment 3 of the present invention. Referring to FIG. 5, a characteristic element of the embodiment 3 is a packet selection unit (extracting means) 21 for extracting the program packets of the predetermined coded program signals from the inputted streaming signals in accordance with a predetermined sequence, and outputting the switch signal switched over when in the extraction process and when in the non-extraction process. Specifically, to begin with, the packet selection unit 21 extracts the PSI packet (stream management packet). Next, the packet selection unit 21 extracts the program packets of the coded program signals in sequence from the program packet containing the time management information. Configurations other than this are the same as those in the embodiment 2, and the repetitive explanations are omitted.

Given next is an explanation of the function thereof.

The packet selection unit 21 extracts at first the PSI packet and next the program packets of the coded program signals in sequence from the packet containing the time management information. Further, the packet selection unit 21 outputs the switch signal switched over when in the extraction process and when in the non-extraction process. Other functions excluding this are the same as those in the embodiment 2, and the repetitive explanations are omitted.

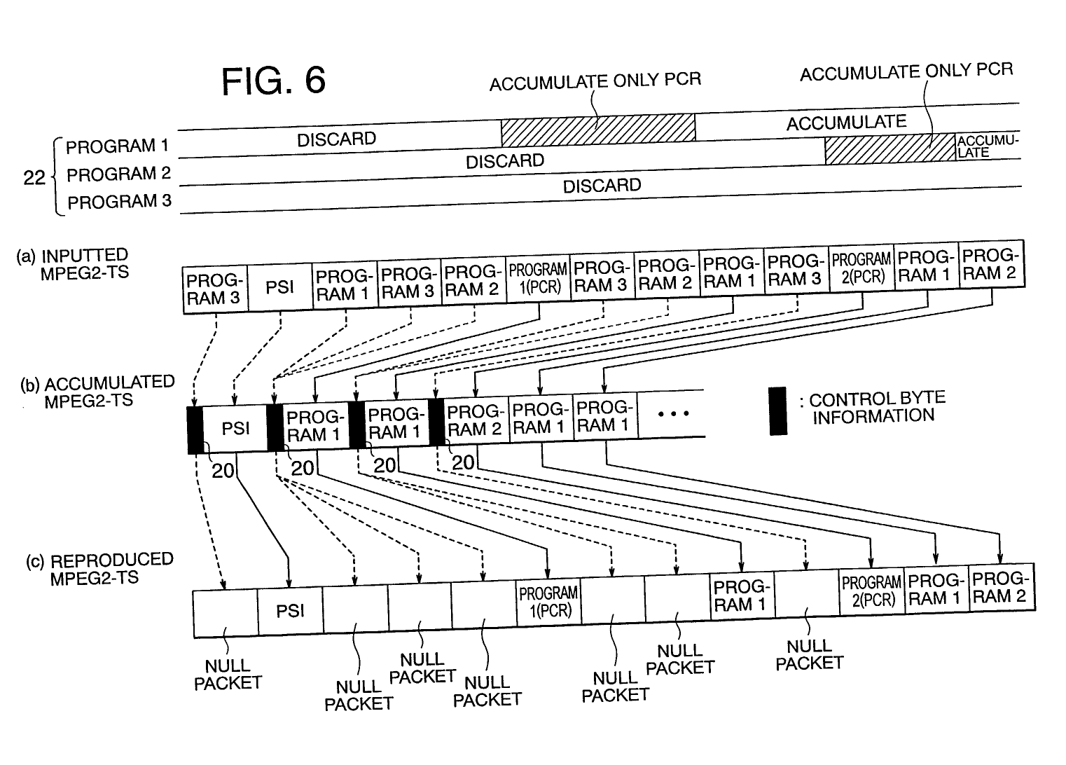

FIG. 6 is an explanatory diagram showing a data flow in a process of recording and reproducing the predetermined coded program signals in the embodiment 3 of the present invention. Referring to FIG. 6, the numeral 22 indicates a discarded/accumulated state of the coded program signal in the inputted streaming signals. Then, as shown in FIG. 6, after the recording has been started, at first the PSI packet is extracted, and next the program packets of the coded program signals are extracted in sequence from the program packet containing the time management information.

As discussed above, according to the embodiment 3, the recording medium 2 is recorded with the PSI packet as the first recorded packet of the predetermined coded program signals, and is therefore, what can not be decoded is not recorded even in the case of a program packet of the predetermined coded program signals. There is obtained an effect that the recording efficiency can be further enhanced. Similarly, the program packets of the coded program signals are recorded in sequence from the packet containing the time management information, thereby obtaining the effect that the recording efficiency can be further enhanced.

Embodiment 4

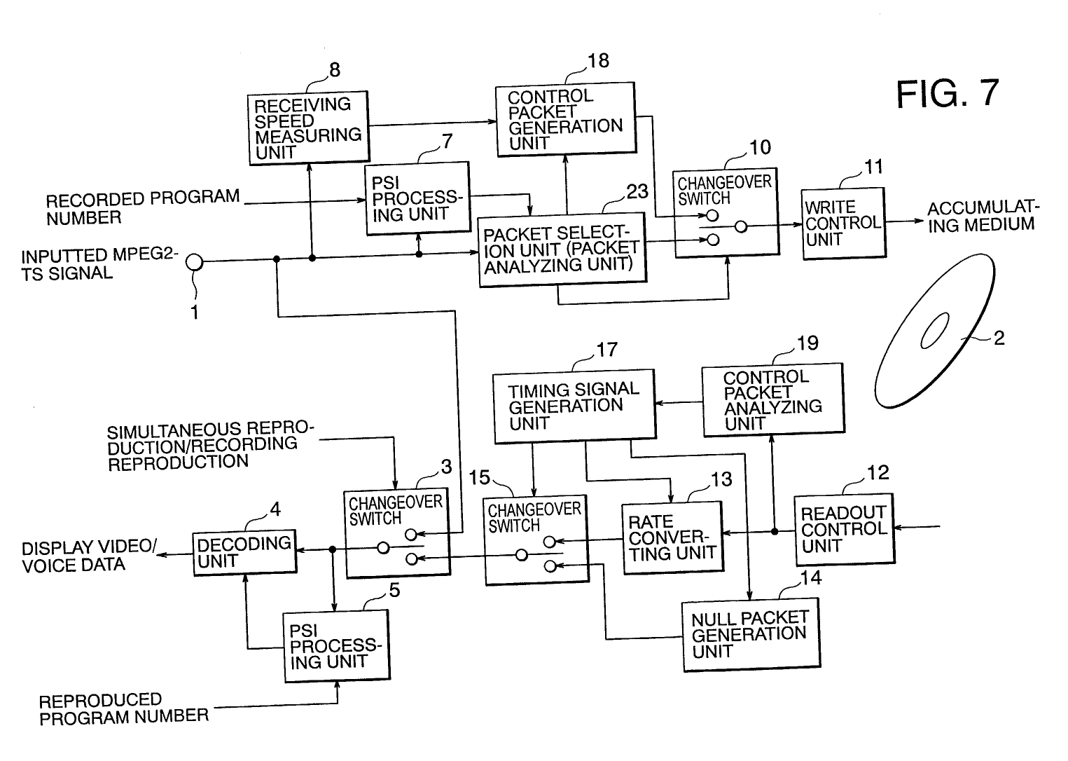

FIG. 7 is a block diagram showing an architecture of the program recording/reproducing apparatus in an embodiment 4 of the present invention. Referring to FIG. 7, a characteristic element of the embodiment 4 is a packet selection unit (extracting means) 23 for extracting the program packets of the predetermined coded program signals from the inputted streaming signals in a predetermined sequence, and outputting the switch signal switched over when in the extraction process and when in the non-extraction process. Specifically, to start with, the packet selection unit 23 extracts the PSI packet and next only the program packets each containing the time management information in the coded program signals in sequence. Further, the packet selection unit 23 extracts the program packets in sequence from an intra-frame coded program packet (which is a so-called I-picture). Configurations other than this are the same as those in the embodiment 2, and the repetitive explanations are omitted.

Next, the function thereof will be described.

The packet selection unit 23 extracts at first the PSI packet and next only the program packets each containing the time management information in the coded program signals in sequence. Further, the packet selection unit 23 extracts the program packets in sequence from the intra-frame coded program packet (which is the so-called I-picture). The packet selection unit 23 also outputs the switch signal switched over when in the extraction process and when in the non-extraction process. Other functions excluding this are the same as those in the embodiment 2, and the repetitive explanations are omitted.

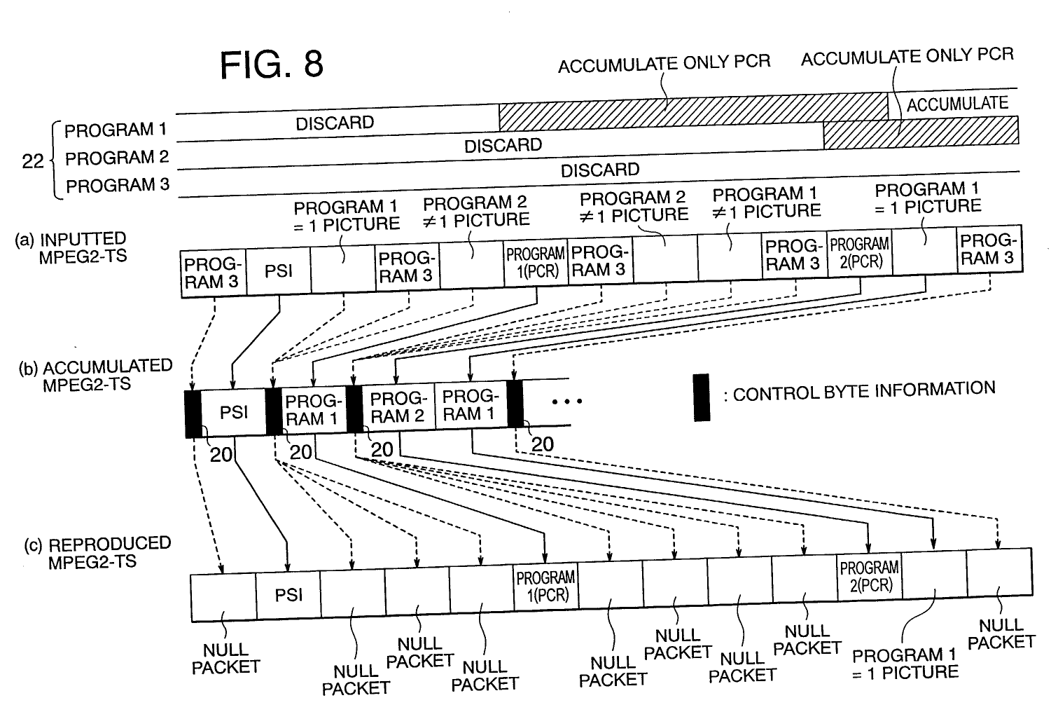

FIG. 8 is an explanatory diagram showing a data flow in a process of recording and reproducing the predetermined coded program signals in the embodiment 4 of the present invention. Then, as shown in FIG. 8, after the recording has been started, at first the PSI packet is extracted, and next only the program packets containing the time management information in the coded program signals are extracted in sequence. Further, the program packets are extracted sequentially from the I-picture.

As discussed above, according to the embodiment 4, the recording medium 2 is recorded with the PSI packet as the first recorded packet of the predetermined coded program signals, and is therefore, what can not be decoded is not recorded even in the case of a program packet of the predetermined coded program signals. There is obtained an effect that the recording efficiency can be further enhanced. Similarly, only the program packets containing the time management information in the coded program signals are recorded in sequence, and the program packets are recorded sequentially from the I-picture, thereby obtaining the effect that the recording efficiency can be enhanced much higher than in the embodiment 3.

Embodiment 5

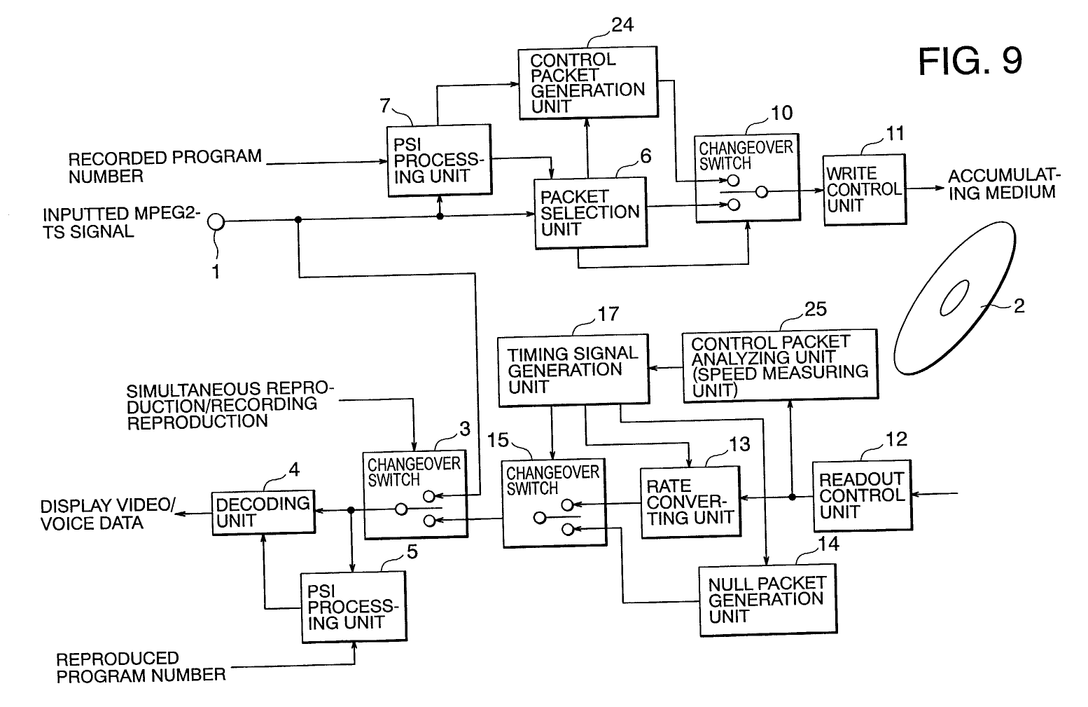

FIG. 9 is a block diagram showing an architecture of the program recording/reproducing apparatus in an embodiment 5 of the present invention. Referring to FIG. 9, characteristic elements of the embodiment 5 are a control packet generation unit 24 for counting the number of packets discarded by the packet selection unit 6 on the basis of a control signal transmitted from the record PSI processing unit 7 and the switch signal of the packet selection unit 6, and outputting the control packet containing the discarded packet count information, and a control packet analyzing unit (speed converting means, speed detecting means) 25 for outputting the discarded packet count information by analyzing the control packet and outputting a piece of receiving speed information estimated from a relationship between a quantity of change of the time management information with respect to, e.g., the two consecutive program packets and the number of packets between the two consecutive program packets. Configurations other than this are the same as those in the embodiment 1, and the repetitive explanations are omitted.

Next, the functions thereof will be described.

The control packet generation unit 24 counts the number of packets discarded by the packet selection unit 6 on the basis of the control signal transmitted from the record PSI processing unit 7 and the switch signal of the packet selection unit 6, and outputs the control packet containing the discarded packet count information. The control packet analyzing unit 25 outputs the discarded packet count information by analyzing the control packet, and outputs the receiving speed information estimated from the relationship between the quantity of change of the time management information with respect to, e.g., the two consecutive program packets and the number of packets between the two consecutive program packets. Configurations other than this are the same as those in the embodiment 1, and the repetitive explanations are omitted.

As discussed above, according to the embodiment 5, the control packet analyzing unit 25 detects, when in the reproducing process, the speed of the streaming signals based on the time management information contained in the streaming signals. It is therefore feasible to reduce the information by the quantity corresponding thereto, recorded on the recording medium 2 and to further enhance the recording efficiency.

Note that the embodiments discussed above have exemplified the program of program signals are time-division-multiplexed based on the MPEG2-TS are inputted, for demultiplexing the predetermined coded program signals out of the streaming signals and recording these program signals. The program recording/reproducing apparatus can, however, exhibit the same effects if constructed to demultiplex the predetermined program signals from the multiplexed signals into which the plurality of program signals are time-division-multiplexed per predetermined multiplexing unit and to record these demultiplexed program signals. In this case, the program recording/reproducing apparatus may include, for example, the extracting means for extracting the predetermined program signals from the multiplexed signals, the recording means for recording the program signals, the reading means for reading the program signals out of the recording means, and the speed converting means for outputting the program signals read by the reading means so that the output interval on each multiplexing unit becomes coincident with the time interval in the multiplexed signals.

Further, the program recording/reproducing method of demultiplexing the predetermined program signals from the multiplexed signals into which the plurality of program signals are time-division-multiplexed per predetermined multiplexing unit and recording these demultiplexed program signals, may comprise the extracting step of extracting the predetermined program signals from the multiplexed signals, the recording step of recording the program signals, the reading step of reading the program signals out of the recording means, and the speed converting step of outputting the program signals read out so that the output interval on each multiplexing unit becomes coincident with the time interval in the multiplexed signals.

As discussed above, according to the present invention, the program recording/reproducing method of demultiplexing the predetermined program signals from the multiplexed signals into which the plurality of program signals are time-division-multiplexed per predetermined multiplexing unit and recording these demultiplexed program signals, comprises the extracting step of extracting the predetermined program signals from the multiplexed signals, the recording step of recording the program signals, the reading step of reading the program signals out of the recording means, and the speed converting step of outputting the program signals read out so that the output interval on each multiplexing unit becomes coincident with the time interval in the multiplexed signals. It is therefore possible to attain the highly efficient recording by discarding the signals excluding the predetermined program signals. Besides, the algorithm taken when reproduced is not that the program signals are simply read from the recording means and thus outputted, but that the readout program signals are outputted after the output interval on each multiplexing unit has been set coincident with the time interval in the multiplexed signals. Therefore, the state of the reproduced program signals becomes the same as the state on the multiplexed signals, thereby obtaining the effect in which the trouble such as the buffer overflow or underflow does not occur.

According to the present invention, the program recording/reproducing apparatus for demultiplexing the predetermined program signals from the multiplexed signals into which the plurality of program signals are time-division-multiplexed per predetermined multiplexing unit and recording these demultiplexed program signals, comprises the extracting means for extracting the predetermined program signals from the multiplexed signals, the recording means for recording the program signals, the reading means for reading the program signals out of the recording means, and the speed converting means for outputting the program signals read by the reading means so that the output interval on each multiplexing unit becomes coincident with the time interval in the multiplexed signals. It is therefore possible to attain the highly efficient recording by discarding the signals excluding the predetermined program signals. Besides, the algorithm taken when reproduced is not that the program signals are simply read from the recording means and thus outputted, but that the readout program signals are outputted after the output interval on each multiplexing unit has been set coincident with the time interval in the multiplexed signals. Therefore, the state of the reproduced program signals becomes the same as the state on the multiplexed signals, thereby obtaining the effect in which the trouble such as the buffer overflow or underflow does not occur.

According to the present invention, the program recording/reproducing apparatus, to which the streaming signals of which the plurality of program signals are time-division-multiplexed based on the MPEG2-TS are inputted, demultiplexes the predetermined coded program signals out of the streaming signals and records these program signals. The program recording/reproducing apparatus includes the extracting means for extracting the program packets of the predetermined coded program signals from the streaming signals, the recording means for recording the respective program packets and the discarded packet count of the packets discarded between the two consecutive program packets, the reading means for reading the coded program signals out of the recording means, and the speed converting means for outputting the coded program signals read out by the reading means in a way that inserts the null packets corresponding to the discarded packet count in between the two consecutive program packets. With this architecture, it is possible to attain the efficient recording by discarding the packets other than the predetermined coded program signals. Besides, the algorithm taken when reproduced is not that the program signals are simply read from the recording means and thus outputted, but that the readout program signals are outputted after the output interval on each multiplexing unit has been set coincident with the time interval in the multiplexed signals. Therefore, the state of the reproduced program packet becomes the same as the state on the streaming signals, thereby obtaining the effect in which the trouble such as the buffer overflow or underflow does not occur.

According to the present invention, there is provided the speed detecting means for detecting the speed of the steaming signals based on the number of packets contained per unit time when receiving the streaming signals. The speed converting means outputs the program signals at the speed detected. Hence, there are obtained effects in which the reproduced program packets can be brought into absolutely the same state as in the case of extracting the program packets directly from on the streaming signals and reproducing them, and the trouble such as the buffer overflow or underflow can be more surely prevented. Further, the streaming signals and the reproduced coded program signals can be brought into the same sate, and hence the effect is that the single decoding unit is capable of similarly decoding the predetermined coded program signals.

According to the present invention, there is provided the speed detecting means for detecting, when in the reproducing process, the speed of the streaming signals on the basis of the time management information contained in the streaming signals. The speed converting means outputs the coded program signals at the speed detected. Hence, there are obtained effects in which the reproduced program packets can be brought into absolutely the same state as in the case of extracting the program packets directly from on the streaming signals and reproducing them, and the trouble such as the buffer overflow or underflow can be more surely prevented. Further, the streaming signals and the reproduced coded program signals can be brought into the same sate, and hence the effect is that the single decoding unit is capable of similarly decoding the predetermined coded program signals.

Then, the recording means records one control packet structured in the same format as the program packet as a substitute for the packet discarded. With this contrivance, the recording means may record the discarded packet count of the packets discarded between the two consecutive program packets, or may record the discarded packet count of the packets discarded between the two consecutive program packets by recording the discarded packet count of the packets discarded between the two consecutive program packets at every interval therebetween. Especially in the latter case, the quantity of the information recorded for recording the number of the packets discarded is reduced down to a much smaller level than in the former case, so that there is the effect that the recording efficiency can be drawn out at the maximum.

Moreover, the recording means may record, for example, the stream management packet as the first recording packet of the predetermined coded program signal. There are yielded the effect of eliminating a possibility of recording what can not be decoded even if being the program packet of the predetermined coded program signals, and the effect that the recording efficiency can be further enhanced. The additional effect is that the program packet containing the time management information or the intra frame coded program packet is recorded next to the stream management packet, thereby further increasing the recording efficiency for the same reason.

Note that the recording means used for the purpose described above may be exemplified such as a magnetic tape, a magnetic disk, an optical disk etc.

The present invention has been discussed by way of the embodiments but may be modified in many forms within the range of the gist of the present invention, and these modifications are not excluded from the scope of the present invention.

What is claimed is:

1. A program recording/reproducing method of demultiplexing predetermined program signals from multiplexed signals into which a plurality of program signals are time-division-multiplexed per predetermined multiplexing unit and recording these demultiplexed program signals, comprising:
an extracting step of extracting the predetermined program signals from the multiplexed signals;
a recording step of recording the program signals on recording means; a reading step of reading the program signals out of the recording means; and
a speed converting step of outputting the program signals read out so that an output interval on each multiplexing unit becomes coincident with a time interval in the multiplexed signals.

2. A program recording/reproducing apparatus for demultiplexing predetermined program signals from multiplexed signals into which a plurality of program signals are time-division-multiplexed per predetermined multiplexing unit and recording these demultiplexed program signals, comprising:
extracting means for extracting the predetermined program signals from the multiplexed signals;
recording means for recording the program signals;
reading means for reading the program signals out of the recording means; and
speed converting means for outputting the program signals read by said reading means so that the output interval on each multiplexing unit becomes coincident with the time interval in the multiplexed signals.

3. A program recording/reproducing apparatus, to which streaming signals of which a plurality of program signals are time-division-multiplexed based on an MPEG2-TS are inputted, for demultiplexing predetermined coded program signals out of the streaming signals and recording these program signals, said apparatus comprising:
extracting means for extracting program packets of the predetermined coded program signals from the streaming signals;
recording means for recording the respective program packets and a discarded packet count of the packets discarded between two consecutive program packets;
reading means for reading the coded program signals out of said recording means; and
speed converting means for outputting the coded program signals read out by said reading means after inserting null packets corresponding to the discarded packet count in between the two consecutive program packets.

4. A program recording/reproducing apparatus according to claim 3, further comprising speed detecting means for detecting a speed of the steaming signals based on the number of packets contained per unit time when receiving the streaming signals,
wherein said speed detecting means out puts the program signals at the speed detected.

5. A program recording/reproducing apparatus according to claim 3, further comprising speed detecting means for detecting, during a reproducing process, a speed of the streaming signals on the basis of time management information contained in the streaming signals,
wherein said speed converting means outputs the coded program signals at the speed detected.

6. A program recording/reproducing apparatus according to claim 3, wherein said recording means records one control packet structured in the same format as the program packet as a substitute for the discarded packet, thereby recording a discarded packet count of the packets discarded between two consecutive program packets.

7. A program recording/reproducing apparatus according to claim 3, wherein said recording means records a discarded packet count of the packets discarded between two consecutive program packets at every interval therebetween, thereby recording a discarded packet count of the packets discarded between two consecutive program packets.

8. A program recording/reproducing apparatus according to claim 3, wherein said recording means records a stream management packet as a first recording packet of the predetermined coded program signal.

9. A program recording/reproducing apparatus according to claim 8, wherein said recording means records a program packet containing time management information after the stream management packet, and subsequently records an intra frame coded program packet.

10. A program recording/reproducing apparatus according to claim 3, wherein said recording means records each program packet and the discarded packet count of the packets discarded between the two consecutive program packets on a magnetic tape, a magnetic disk, or an optical disk.
